(19) United States
(12) Patent Application Publication
(10) Pub. No.: US 2025/0094623 A1
(43) Pub. Date: Mar. 20, 2025

(54) METHOD AND SYSTEM FOR ROBUST PSEUDONYMIZATION THAT RETAINS DATA DIVERSITY

(71) Applicant: GOOGLE LLC, Mountain View, CA (US)

(72) Inventor: Alexander Mihlin, San Jose, CA (US)

(21) Appl. No.: 18/387,629

(22) Filed: Nov. 7, 2023

Related U.S. Application Data
(60) Provisional application No. 63/538,662, filed on Sep. 15, 2023.

(51) Int. Cl. G06F 21/62; G06N 20/00

(52) U.S. Cl. CPC G06F 21/6245; G06N 20/00

(57) ABSTRACT

Method(s) of determining frequent templates (e.g., single tokens/words used by enough distinct users) and frequent template sets (permutations of the frequent templates) for storage in a PII-free template database are provided, where the frequent template sets can be derived from frequent templates and combined thereof. The frequent template sets can also be indexed with IDs for the frequent template sets, where the IDs are stored in the PII-free template database in association with the frequent template sets. Method of redacting a query is also provided, where the frequent templates and/or the frequent template sets in the PII-free template database can be applied to redact one or more words in a query that potentially reveal personal identifiable information (PII). The query with one or more redacted words can be processed, using a generative model, to generate a PII-free query, for use to train the generative model or other machine learning models.

### BACKGROUND

Automated assistants (also known as “interactive assistants”, “chatbots”, “intelligent assistants”, etc.) may be interacted with by a user via a variety of client devices, such as smart phones, tablets, wearable devices, automobile systems, standalone speakers, and so forth. The automated assistants receive input (e.g., typed and/or spoken input) from the user and respond with responsive content (e.g., visual and/or audible natural language output). The automated assistants often include one or more models trained to process the received input (or data derived therefrom), to generate the responsive content to be rendered to the user.

The model(s) may be trained at least partly based on historical input (typed and/or spoken) previously received from users. However, using query-response pairs obtained from historical interactions between users and automated assistants can expose personal information of the users to human annotators who annotate the historical input and/or other data for training of the model(s). For instance, if a model is trained using training data that includes PII, it may be possible for a malicious user to retrieve that PII by asking specific questions of the automated assistant (e.g., “When is Michael Schwartzman of Philadelphia scheduled to depart JFK?”). Accordingly, the historical input used to train the one or more models may be subject to strict wipeout rules if containing personal information, including being deleted any time at the request of the user.

### SUMMARY

Implementations disclosed herein relate to generating pseudonymised data from data/information (e.g., a user utterance received via an automated assistant, a response generated by the automated assistant that is responsive to the user utterance, home-graph names, timer and alarm labels, reminder text, etc.) that possibly conveys personally identifiable information (PII). For instance, natural language user queries conveying PII can be received at an automated assistant. The natural language user queries can be processed to remove the PII and/or to replace the PII with PII-free content, so that the generated pseudonymised data is devoid of PII and thus is not subject to strict wipeout rules. The generated pseudonymised data, for instance, can then be applied to train or validate one or more machine learning models included in (or accessible via) the automated assistant. The method and system of automatic pseudonymization disclosed herein removes PII from various natural language exchanged during human-to-computer dialogs, while increasing data diversity. This may reduce the risk of triggering privacy issues, reduce consumption of computing resources (e.g., associated with re-generating training data for training the one or more machine learning models), and/or reduce or avoid labor cost (associated with manually filtering data or information that contains PII), while ensuring diversity of the training data and increasingly facilitating personalized user experiences.

In various implementations, a human-to-computer dialog session can be established between a user and an automated assistant. During the human-to-computer dialog session, one or more spoken and/or typed utterances can be received from the user. The one or more utterances can be received, for instance, via a client device at which the automated assistant is installed (or at which the automated assistant is remotely accessible).

When spoken, the aforementioned one or more utterances can be processed to generate a transcript for each of the one or more utterances. For example, the automated assistant can include an automatic speech recognition (ASR) engine that processes each of the one or more utterances to generate the transcript for each of the one or more utterances. For the transcript of each utterance (from the one or more utterances), one or more candidate words in the transcript that potentially convey personal identifiable information (PII) can be identified.

In various implementations, occurrences of the one or more candidate words in log(s) of reference transcripts generated from historical human-to-computer dialogs can be determined. Based on the occurrences, one or more of the candidate words can be flagged as not conveying PII. PII can include, for instance, names, addresses, telephone numbers, financial information, nicknames of structures, appliances, rooms, email addresses, etc.

In various implementations, one or more other words in the transcript can be redacted based on one or more redacting rules, while the one or more of the candidate words that are flagged as not conveying PII can be preserved, to generate a redacted transcript having one or more redacted slots that correspond to the one or more redacted words. The redacted transcript can be processed as input, e.g., using a generative model trained on redacted data, to generate output corresponding to a modified transcript that has the one or more redacted slots of the transcript filled with content free of PII. In various implementations, one or more training instances can be generated based on the modified transcript of each utterance.

In various implementations, a phrase repeated enough times (e.g., greater than one or two times, such as fifty times) by distinct users (e.g., greater than one or two different users, such as greater than fifty users) in a document or logs can be considered the content free of PII (or PII-free content). In these implementations, a phrase either not repeated enough times or not repeated by enough distinct users can be considered content that potentially or possibly conveys PII.

As a non-limiting working example, a user can provide a particular utterance of “My address is 5 Olive St., Mountain View” to an automated assistant. This particular utterance can be processed to generate a transcript (sometimes referred to as “speech recognition”) of “My address is 5 Olive St., Mountain View” in natural language. The phrases “my address is”, of “St.” and of “Mountain view” may be flagged as not being PII, e.g., via rules such as the removal of stop words, and/or by being determined as previously revealed enough times by enough different users. By contrast, the phrase “5 Olive” is not determined as previously revealed enough times by enough different users. Consequently, the transcript of “My address is 5 Olive St., Mountain View” can be modified to generate a redacted transcript, e.g., “My address is REDACTED REDACTED St., Mountain View” (or “My address is REDACTED St., Mountain View”). The redacted transcript can be a transcript that replaces one or more phrases (e.g., “5 Olive”) in the transcript (e.g., “My address is 5 Olive St., Mountain View”) that potentially reveals PII (e.g., determined as not revealed previously by enough different users), with a respective redacted slot of “REDACTED”.

The redacted transcript can be processed as input, using a generative model (e.g., a large language model, “LLM”) trained on PII-free training data, to generate output that replaces each redacted slot of “REDACTED” in the redacted transcript with corresponding PII-free content. In the above working example, the redacted transcript of “My address is REDACTED St., Mountain View” (or “My address is REDACTED REDACTED St., Mountain View”) can be processed using the LLM, to output a text of “My address is 8 Orange St., Mountain view”, where “8 Orange” has been identified from queries of a significant number of users (e.g., 50) and thus is free of PII. The text of “My address is 8 Orange St., Mountain view” can be subsequently used, for instance, to generate PII-free training data. In this way, not only common phrase(s) such as “set an alarm” can be collected for training one or more machine learning models, but additional phrases not as common can be collected as well and be modified to remove PII, for purpose of training the one or more machine learning models in handling more complex and diversified queries.

In various implementations, not only user queries and user input can be redacted using methods described above, but free-text fields including contextual information/data, timer and alarm labels, reminder text, checkable strings, and/or room/device names within a home-graph can also be redacted. A home graph can be a database storing contextual data indicating connections and relationships between network devices (e.g., security camera, laptop, television, stand-alone speaker, smart thermostat, etc.) within a structure (e.g., a house) that function as hubs (e.g., security hub, energy management hub, etc.), users, and other elements (e.g., rooms such as bedroom or living room) of the structure. It's noted that different structures can have different rooms and/or devices.

The structure and/or home graph that represents it can be associated with an account of a user (e.g., an owner) of the structure, one or more rooms being part of the structure, one or more devices (or object) within the structure (the one or more devices can be from the same or different manufacturers) that the automated assistant can interact with, and one or more labels (e.g., a label that identifies the structure such as “John's house”, a label that identifies a room as “Tom's bedroom”, a label that identifies a lamp as “bedroom lamp”). The contextual data stored in the home graph of the structure can be provided to the automated assistant to execute one or more user requests received within the structure. In some implementations, the home graph can include trait information of the one or more devices, which indicates static attributes (e.g., temperature unit or mode) of the one or more devices, current states (e.g., “ON”, “OFF”, a state of “brightness” for a lamp) of the one or more devices, and/or commands for controlling the one or more devices.

As a practical example, a user within a structure may provide a user request of “What alarms do I have for kira” to an automated assistant having a user account of the user. In response to the user request, contextual data relating to the alarms can be retrieved from a home graph of the structure and be provided to the automated assistant, where the contextual data can indicate, for instance, existence of an alarm, e.g., “alarm: pick up Kira from the airport on May 3 at 5”. Based on the user request (e.g., utterance: “what alarms do I have for kira”) and the contextual data (“alarm: pick up Kira from the airport on May 3 at 5), the automated assistant can generate a response (e.g., “pick up Kira from the airport on May 3 at 5”) responsive to the user request. In this practical example, data received by the automated assistant (e.g., utterance: “what alarms do I have for kira”; alarm: pick up Kira from the airport on May 3 at 5) can be redacted to generate pseudonymised data (i.e., utterance: “what alarms do I have for REDACTED”; alarm: pick up REDACTED from the airport on REDACTED at REDACTED). Alternatively, based on “Kira” appearing in both the utterance and the home graph, the data received by the automated assistant (e.g., utterance: “what alarms do I have for kira”; alarm: pick up Kira from the airport on May 3 at 5) can be redacted as follows: utterance: “what alarms do I have for REFERENCE0”; alarm: pick up REFERENCE0 from the airport on REDACTED at REDACTED, where “Kira” is replaced with a reference (e.g., “REFERENCE0”) to the name “Kira”.

In various implementations, techniques relating to determination of content (e.g., a word) to be redacted are provided. Determining what needs to be redacted is a part of pseudonymization, and can be robustly achieved by utilizing a PII-free template database to determine content from a user query (or system query, etc.) that needs not to be redacted. The PII-free template database can be generated by removing PII from logs (e.g., that are collected from human-to-computer dialogs). This requires template construction and appropriate redaction during template construction.

As a non-limiting example of template construction, given a user utterance of “I am saying set a timer for 4:30 p.m.” identified from the logs, the user utterance can be processed to determine whether a corresponding template can be generated therefrom. Processing of the user utterance from the logs can include: removing stop words (e.g., “I am”, “a”, “the”, “for”, etc.) from the user utterance of “I am saying set a timer for 4:30 p.m.” to generate a stop word free content of “saying set timer 4:30 p.m.”; removing content other than letter(s) and number(s) from the stop word free content to generate a natural language expression containing only letters and numbers (e.g., “saying set timer 430 pm”); and/or lemmatizing one or more words in the natural language expression containing only letters and numbers, to generate a lemmatized natural language expression (e.g., “say set timer 430 pm”).

Processing of the user utterance from the logs can further include: redacting the lemmatized natural language expression, to generate one or more redacted natural language expressions. Optionally, such redacting can be performed using a brute-force approach, where given an utterance of “Call Emmy McMahon”, a total number of 7(=2³−1) redacted natural language expressions can be generated, as follows:
Call Emmy McMahon
Call Emmy REDACTED
Call REDACTED McMahon
Call REDACTED REDACTED
REDACTED Emmy McMahon
REDACTED Emmy REDACTED
REDACTED REDACTED McMahon

Continuing with the lemmatized natural language expression of “say set timer 430 pm”, a total number of five tokens (“say” “set” “timer” “430” “pm”) can be determined (i.e., N=5). In this case, there can be a plurality of (e.g., 25−1=31) redacted natural language expressions (including, for example, “say set timer REDACTED pm”). Similarly, for a query that includes N words/tokens, there can be (2^{N}−1) possible redactions. However, when N is greater than 10, the brute-force approach becomes impractical as high computing and memory resources would be needed to determine all possible redactions (i.e., the plurality of redacted natural language expressions).

Processing of the user utterance from the logs can further include: selecting one (e.g., “say set timer REDACTED pm”) redacted natural language expression from the one or more natural language expressions to remove one or more redacted words from the selected redacted natural language expression, thereby obtaining a template (e.g., “say set timer pm”). The generated template (e.g., “say set timer pm”) can be indexed and stored in a PII-free template database, for subsequent use in identifying content from user queries (and other free-text fields) that is PII-free. It's noted that different user queries can be processed to correspond to the same template. For instance, using the method described above, a first utterance of “turn on the light in Mike's room please” and a second utterance of “turn on the light in Julie's and Martha's rooms” can both contribute to a template of “turn light room”.

In some implementations, optionally, processing of the user utterance from the logs can further include: validating the selected redacted natural language expression to determine whether the selected redacted natural language expression is free of PII, prior to removing the one or more redacted words.

In various implementations, to save computing and memory resources, templates for the PII-free template database can be generated using an Apriori-based algorithm/approach instead of using the brute-force approach described previously. In the Apriori-based approach (sometimes referred to as “modified Apriori algorithm”), as a non-limiting example, a plurality of user queries (e.g., four queries of “a”, “dac”, “bca”, and “c”, where “a”, “b”, “c”, and “d” each represent a single word) can be acquired from the logs, and one or more wordsets (e.g., {a}, {c}, and {ac}) satisfying a frequency threshold (e.g., 2) can be identified from the plurality of user queries. The one or more wordsets (e.g., {a}, {c}, and {ac}) can be determined by first determining whether occurrence of each of single tokens {a}, {b}, and {c} within the logs satisfies the frequency threshold. In this non-limiting example, {a} and {c} (but not {b}) can be determined as satisfying the frequency threshold by appearing more than twice in the logs. Based on {a} and {c} satisfying the frequency threshold, a combination of {a} and {c} (i.e., {a, c}) can be determined as satisfying the frequency threshold. Accordingly, instead of considering 2³−1(=7) possible redactions, only 3+1(=4) possible redactions are considered.

Although the above techniques are described with respect to the processor(s) of the client device, it should be understood that is for the sake of example and is not meant to be limiting. For example, in other implementations, the processor(s) may be remote from the client device such that the processor(s) are implemented by a remote system.

By using techniques described herein, one or more advantages can be achieved. As one non-limiting example, techniques described herein prevent queries from being associated with users when privacy is a concern. For instance, by removing/redacting/replacing PII in utterances received from users (or in utterances generated by automated assistants, and/or in labels for timers (alarms, and/or reminders) to generate PII-free content, one or more machine learning models can be trained on PII-free training data derived from the generated PII-free content. This ensures diversity of the training data while reducing the risk of triggering privacy issues with respect to the training data. Using techniques described herein to pseudonymize logs of human-to-computer dialogs also prevents PII from being inadvertently trained into LLMs, thereby preventing that PII from being misappropriated by cleverly-worded queries.

The above description is provided as an overview of only some implementations disclosed herein. Those implementations, and other implementations, are described in additional detail herein.

### BRIEF DESCRIPTION OF THE DRAWINGS

The above and other aspects, features, and advantages of certain implementations of the present disclosure will be more apparent from the following description taken in conjunction with the accompanying drawings. In the drawings:

FIG. 1A depicts a block diagram of an example environment that demonstrates various aspects of the present disclosure, and in which implementations disclosed herein can be implemented.

FIG. 1B depicts an example of a home graph for a structure before and after mixing that removes personally identifiable information (PII), in accordance with various implementations.

FIG. 2 schematically illustrates an example method of generating PII-free templates for storage in a PII-free template database, in accordance with various implementations.

FIG. 3 schematically illustrates an example method of redacting a user query using templates stored in a PII-free template database, in accordance with various implementations.

FIG. 4 depicts an example method of pseudonymization, in accordance with various implementations.

FIG. 5 depicts another example method of pseudonymization, in accordance with various implementations.

FIG. 6 illustrates an example architecture of a computing device, in accordance with various implementations.

### DETAILED DESCRIPTION

The following description with reference to the accompanying drawings is provided for understanding of various implementations of the present disclosure. It's appreciated that different features from different implementations may be combined with and/or exchanged for one another. In addition, those of ordinary skill in the art will recognize that various changes and modifications of the various implementations described herein can be made without departing from the scope and spirit of the present disclosure. Descriptions of well-known or repeated functions and constructions may be omitted for clarity and conciseness.

The terms and words used in the following description and claims are not limited to the bibliographical meanings, and are merely used to enable a clear and consistent understanding of the present disclosure. Accordingly, it should be apparent to those skilled in the art that the following description of various implementations of the present disclosure is provided for the purpose of illustration only and not for the purpose of limiting the present disclosure as defined by the appended claims and their equivalents.

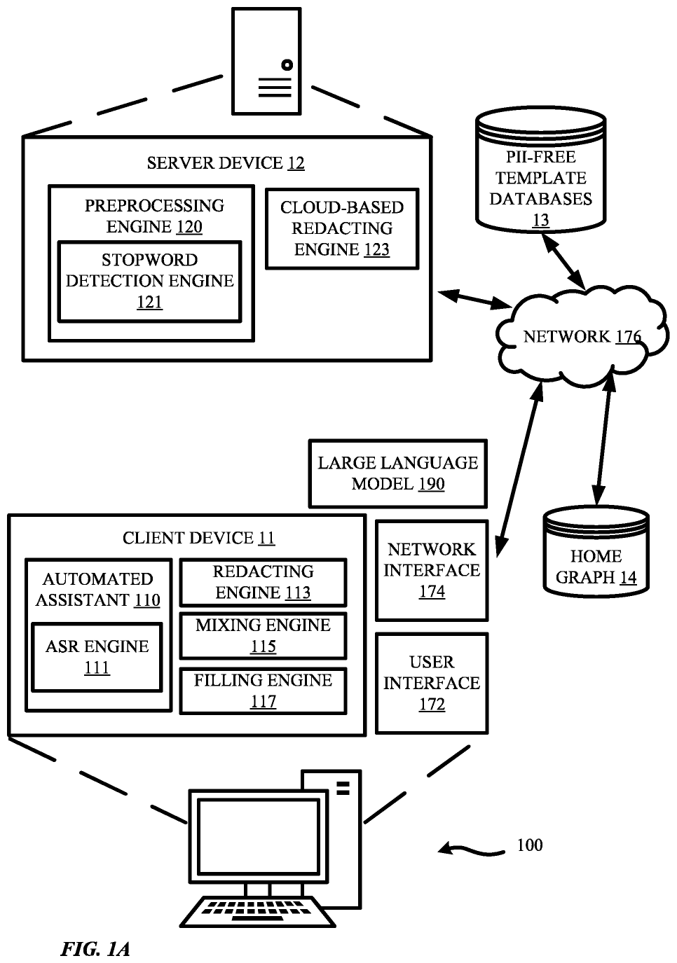

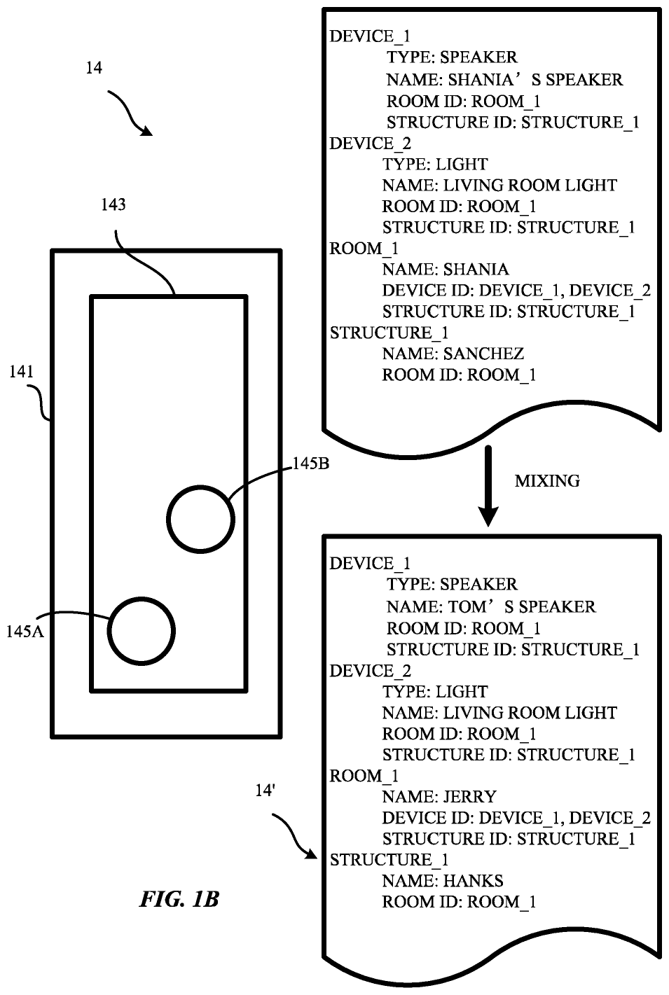

FIG. 1A depicts a block diagram of an example environment 100 that demonstrates various aspects of the present disclosure, and in which implementations disclosed herein can be implemented. FIG. 1B depicts an example of a home graph for a structure before and after mixing that removes personally identifiable information (PII), in accordance with various implementations. As shown in FIG. 1A, the environment 100 can include a client device 11. The client device 11 can be, for example, a standalone speaker, a laptop, a desktop computer, a tablet, a cell phone, a smart TV, a messaging device, a personal digital assistant (PDA), a wearable computing device, a vehicular computing device, or any other applicable client device. The client device 11 can include a local automated assistant 110 locally installed at the client device 11, or a cloud-based automated assistant remotely accessible via the client device 11. The computing device 1 can further include one or more user interface input devices 172 such as a keyboard, pointing devices such as a mouse, trackball, touchpad, or graphics tablet, a scanner, a touch screen incorporated into the display, audio input devices such as voice recognition systems, microphones, and/or other types of input devices.

In some implementations, the client device 11 can further include a user input engine (not illustrated) to detect various types of user input at the client device 11. In some examples, the user input detected at the client device 11 can include spoken input detected via microphone(s) of the client device 11. In these examples, the microphone(s) of the client device 11 can generate audio data that captures spoken utterance(s) included in the spoken input. In other examples, the user input detected at the client device 11 can include touch input detected via user interface input device(s) 172 (e.g., touch sensitive display(s)) of the client device 11, and/or typed input detected via user interface input device(s) (e.g., touch sensitive display(s) and/or keyboard(s)) of the client device 11. In these examples, the user interface input device(s) 172 of the client device 11 can generate textual data that captures the touch input and/or the typed input.

In various implementations, the local automated assistant 110 can include an automatic speech recognition (ASR) engine 111. The ASR engine 111 can process, using one or more streaming ASR models (e.g., a recurrent neural network (RNN) model, a transformer model, and/or any other type of ML model capable of performing ASR), streams of audio data that capture spoken utterances and that are generated by microphone(s) of the client device 11 to generate corresponding streams of ASR output. Notably, the streaming ASR model can be utilized to generate the corresponding streams of ASR output as the streams of audio data are generated.

In various implementations, the corresponding streams of ASR output can include, for example, streams of ASR hypotheses (e.g., term hypotheses and/or transcription hypotheses) that are predicted to correspond to spoken utterance(s) of a user that are captured in the corresponding streams of audio data, one or more corresponding predicted measures (e.g., probabilities, log likelihoods, and/or other values) for each of the ASR hypotheses included in the streams of ASR hypotheses, a plurality of phonemes that are predicted to correspond to spoken utterance(s) of a user that are captured in the corresponding streams of audio data, and/or other ASR output. In some versions of those implementations, the ASR engine 111 can select one or more of the ASR hypotheses as corresponding recognized text (sometimes referred to as “speech recognition” or “transcript”) that corresponds to the spoken utterance(s) (e.g., selected based on the corresponding predicted measures).

In various implementations, the local automated assistant 110 can further include a text-to-speech (TTS) engine (not shown), a natural language understanding (NLU) engine (not shown), and/or a fulfillment engine (not shown). The NLU engine can process, using one or more NLU models (e.g., a long short-term memory (LSTM), gated recurrent unit (GRU), and/or any other type of RNN or other ML model capable of performing NLU) and/or grammar-based rule(s), the corresponding streams of ASR (or other typed NL) output to generate corresponding streams of NLU output. The fulfillment engine can cause the corresponding streams of NLU output to be processed to generate corresponding streams of fulfillment data. The corresponding streams of fulfillment data can correspond to, for example, corresponding given assistant outputs that are predicted to be responsive to spoken utterances captured in the corresponding streams of audio data processed by the ASR engine 111.

In various implementations, the client device 11 can be in communication with a server device 12 via one or more networks 176. The one or more networks 176 can be, or can include, for example, a local area network (LAN), a wide area network (WAN) such as the Internet, and/or any other appropriate network. The server device 12 can include, for instance, a preprocessing engine 120 that processes queries from logs (or other files that collect queries from different users, in order to generate one or more PII-free template databases) to remove stop-word(s) from the queries, convert uppercase in the queries to lowercase, remove non-alphanumeric tokens from the queries, and/or lemmatizing word(s) from the queries. For example, the preprocessing engine 120 can include a stopword detection engine 121 for removing stop-words (e.g., “a”, “and”, “or”) from the queries.

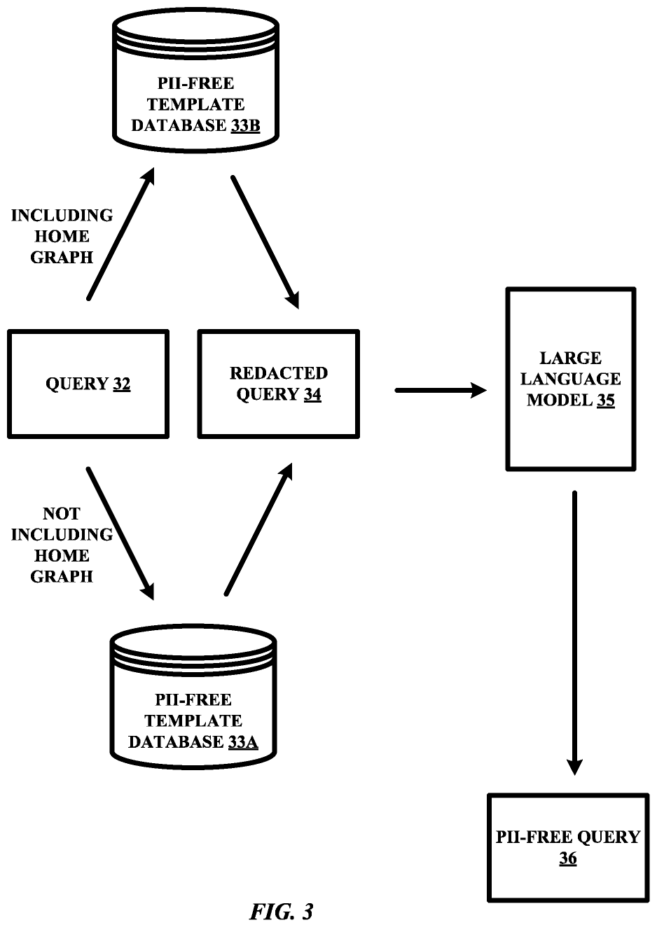

In various implementations, the server device 12 can include a cloud-based redacting engine 123 that processes the queries that have been preprocessed using the preprocessing engine 120. The cloud-based redacting engine 123 can generate a plurality of templates that are PII free and index the plurality of templates in one or more PII-free template databases 13. Detailed implementations will be provided elsewhere in this disclosure (e.g., with reference to FIG. 3).

In various implementations, the client device 11 can include a network interface 174 for communicating with the one or more networks 176. In various implementations, the client device 11 can include a local redacting engine 113, a mixing engine 115, and/or a filling engine 117 (e.g., a PII-free content filling engine). The local redacting engine 113 can process a received query (which can include a portion of home graph 14) by redacting one or more words in the received query. The filling engine 117 can, for instance, replace the redacted one or more words in the received query with PII-free content. In some implementations, the filling engine 117 can replace the redacted one or more words using a trained generative model (e.g., a large language model 190), to generate a PII-free query. The PII-free query can be applied as training data to train a machine learning model, so that the machine learning model is not subject to wipeout rules and can be trained steadily. The mixing engine 115, for instance, can mix device labels within the home graph 14 with device labels from other home graphs associated with different users. While depicted as part of client device 11 in FIG. 1A, it should be understood that one or more of engines 113, 115, and/or 117 may be implemented in whole or in part on server device 12.

Although FIG. 1A is described with respect to a single client device, it should be understood that is for the sake of example and is not meant to be limiting. For example, one or more additional client devices of a user can also implement the techniques described herein. For instance, the client device 11, the one or more additional client devices, and/or any other computing devices of the user can form an ecosystem of devices that can employ techniques described herein. These additional client devices and/or computing devices may be in communication with the client device 11 and/or the server device 12 (e.g., over the one or more networks 176). As another example, a given client device can be utilized by multiple users in a shared setting (e.g., a group of users, a household, etc.).

Turning now to FIG. 1B, a mixing approach is shown and can be implemented on a home graph (e.g., home graph 14) using the mixing engine 115 in FIG. 1A, to remove PII. Mixing can be one technique to remove PII (e.g., distributed PII) from home graphs. An alternative technique to remove PII from home graphs is a brute-force approach as mentioned previously. The brute-force approach can be applied to remove/redact the distributed PII from home graphs without modifying the home graphs, in case modification of the home graphs is found (and causes inconsistencies in the modified home graphs, e.g., a device named “kitchen light” within a room named “office”) when applying the mixing approach to remove/redact the distributed PII from the home graphs.

Different from the mixing approach where names of devices (or rooms, structures) within one or more home graphs are redacted individually, the brute-force approach redacts a whole query (e.g., having multiple utterances from user(s) and an automated assistant) together, as opposed to redacting each utterance within the whole query individually. It's noted that in the brute-force approach, order of words needs to be considered, which means if a plurality of words have each been repeated enough times by N different users but has not been repeated enough times in the same order by N different users, the plurality of words are still considered as potentially conveying PII and is likely not PII-free content (so that the plurality of words need to be redacted at least partially).

In addition to redacting home graphs (e.g., in cases where the mixing approach causes inconsistencies), the brute-force approach can be applied to redact a query that includes a plurality of utterance collected from user(s) and an automated assistant the user(s) are interacting with. However, as mentioned above, for the query having a length over ten words after being processed to remove stopwords and non-alphanumeric tokens, application of the brute-force approach would require high computing and memory resources. Accordingly, for a query having a length over some number of (e.g., ten) words after being processed to remove stopwords and non-alphanumeric tokens, a modified Apriori algorithm can be applied to remove/redact PII from the query.

As a non-limiting example to illustrate the mixing approach, the home graph 14 can be associated with a structure 141 having a first room 143 (“ROOM_1”), and a first device 145A (“DEVICE_1”) and a second device 145B (“DEVICE_2”) within the first room 143. In this non-limiting example, the home graph 14 can store contextual data indicating trait information (e.g., name, type, etc.) of the first device 145A, the second device 145B, the first room 143, and/or the structure 141. As shown in FIG. 1B, the contextual data can provide that the first device 145A (“DEVICE_1”) has a type of “speaker”, is named by an owner of the structure 141 as “Shania's speaker”, and is located with the first room 143 (“ROOM_1”) of the structure 141. The contextual data can further provide that the second device 145B (“DEVICE_2”) has a type of “light”, is named by an owner of the structure 141 as “living room light”, and is located with the first room 143 (“ROOM_1”) of the structure 141. The contextual data can further provide that the first room 143 (“ROOM_1”) is named “shania”, include the first device 145A (“DEVICE_1”) and the second device 145B (“DEVICE_2”), and is located with the structure 141 (“STRUCTURE_1”). The contextual data can further provide that the structure 141 (“STRUCTURE_1”) is named “sanchez” and includes the first room 143 (“ROOM_1”). The home graph 14 or a portion thereof may be included in a query to be processed by an automated assistant (e.g., the automated assistant 11), for instance, to train one or more ML models of the automated assistant.

It's noted that contextual information stored in (and distributed over) the home graph 14 can be combined to reveal PII for the owner of the structure 141 (“STRUCTURE_1”). For instance, the name of the first device 145A (“DEVICE_1”) and the name of the structure 141 (“STRUCTURE_1”) can reveal that a full name of the owner of the structure 141 (“STRUCTURE_1”) is “Shania Sanchez” (which is PII). This can trigger privacy concerns and sometimes mandatory removal of the PII (here, the owner's full name of “Shania Sanchez”) from the home graph 14 if the home graph 14 (or a portion thereof) is used to derive training data to train one or more machine learning models. To ensure effectiveness of training data generated from the home graph 14 and without subjecting the training data to high risks of privacy issues, a mixing approach can be applied, that identifies PII in the home graph 14, and replaces the identified PII with PII-free content associated with different users.

The identification of PII in the home graph 14 can be performed, for instance, based on one of the one or more PII-free template databases 13 that stores templates specific to home graphs. Applying the mixing approach to the home graph 14 can result in a modified home graph 14′ generated free of PII. The modified home graph 14′ can indicate that the name (or label) of the first device 145A (“DEVICE_1”) is changed from “Shania's speaker” to “Tom's speaker”, the name (or label) of the first room 143 (“ROOM_1”) is changed from “Shania” to “Jerry”, and the name (or label) of the structure 141 (“STRUCTURE_1”) is changed from “Sanchez” to “Hanks”, where “Tom”, “Jerry”, and “Hanks” are users from additional home graphs in addition to the home graph 14. For instance, “Tom” can be the first name of a user owning or being associated with a second structure different from the structure 141, “Jerry” can be the first name of a user owning or being associated with a third structure different from the second structure and the structure 141, and “Hanks” can be the last name of a user owning or being associated with a fourth structure different from the first structure, the second structure, and the structure 141. It's noted that, “Tom”, “Jerry”, and “Hanks”, either alone or in combination, do not reveal PII as each of them has been repeated enough times by different users in the PII-free template database that stores home graph templates, and any two of “Tom”, “Jerry”, “Hanks” are not from the same user.

Optionally, modifying the home graph 14 to generate the modified home graph 14′ can be performed using a generative model (e.g., the LLM 190 which is trained based on PII-free training data). The generative model can be, for instance, a multimodal model (e.g., a transformer) trained in different modalities and/or languages, which understands information across text and images. In some implementations, the generative model can be trained to learn types of tokens that need to be filled in with PII-free content. For instance, the generative model can be trained to learn a first special token of “REDACTION” (or “REDACTED”) and one or more special tokens of “REFERENCE0”˜“REFERENCEn”, to replace the first and the one or more special tokens with PII-free content/token(s). Optionally, the modified home graph 14′ (instead of the home graph 14) or a portion thereof can be applied to generate training data for model training. For instance, a portion of the modified home graph 14′ can be applied to train the LLM 190 since the modified home graph 14′ is free of PII, so that the LLM 190 continues to be trained using PII-free data.

Optionally, the modified home graph 14′ or a portion thereof can be indexed and stored in a database specific to home graphs, such as the aforementioned PII-free template database specific to home graphs. It's noted that, in some implementations, templates derived from home graphs and templates derived from queries not containing home graphs (or portion thereof) can be stored in separate PII-free template databases.

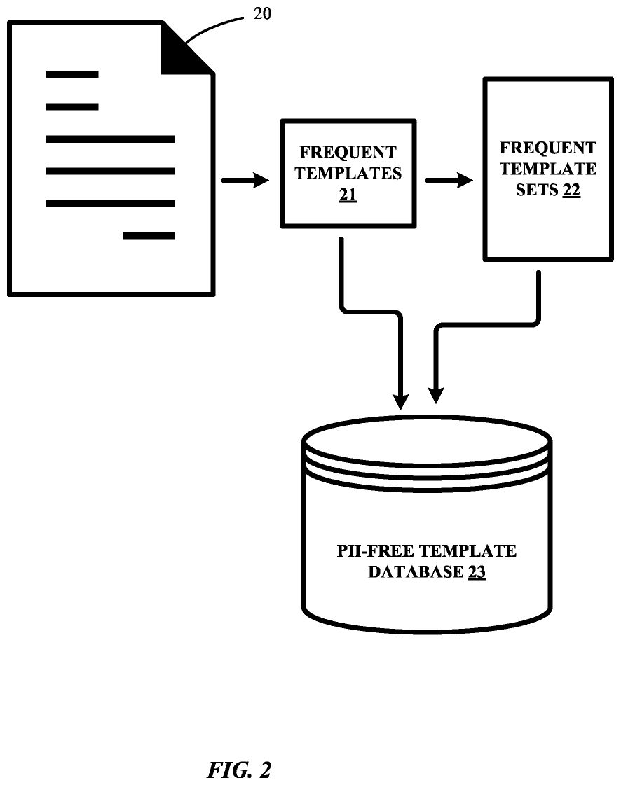

In various implementations, a query can include utterance(s) instead of (or in addition to) a home graph. In these implementations, the mixing approach can be inapplicable as order of words sometimes matter in the utterance(s). Or, the mixing approach can be unfavored when modification to home graphs are to be avoided. In these cases, instead of the mixing approach, an alternative approach can be applied. For instance, FIG. 2 schematically illustrates generation of PII-free templates from logs, for storage in a PII-free template database, in accordance with various implementations. As shown in FIG. 2, log(s) 20 can be received and can include a plurality of queries from which templates 22 free of PII can be derived and stored in one or more PII-free template databases 23.

As a non-limiting working example, the plurality of queries can include a first query, a second query, and a third query. The first, second, and third queries can be pre-processed (e.g., using the preprocessing engine 120 to remove stopwords, convert to lowercase, etc.), respectively, to generate three tokenized queries (i.e., first tokenized query, second tokenized query, and third tokenized query) shown as below:

| --- | |
|---|---|
| a b | |
| c | |
| --- | |
| a | |
| e d c | |
| --- | |
| c d | |
| --- | (1) |

In the above non-limiting working example, the first tokenized query can be simplified as “a b; c” which includes (or is divided into) two query units: “a b” and “c”, the second tokenized query (simplified as “a; e d c”) can include (or be divided into) two query units: “a” and “e d c”, and the third tokenized query (simplified as “c d”) can include one and only one query unit “c d”. The letters of “a” “b” “c” “d” and “e” can each represent a token (or a single word) for the purpose of illustration. A “query unit” here refers to a unit that is to be redacted together. That is, token “a” and “token b” in the query unit “a b” will be redacted together, while query unit “a b” and query unit “c” would be redacted separately/individually. The three tokenized queries can be separated by a dashed line “- - -” for the purpose of illustration. For illustrative purposes, query unit “a b” in the first tokenized query (simplified as “a b; c”) can be from a user utterance, and query unit “c” in the first tokenized query (simplified as “a b; c”) can be from a system utterance (e.g., utterance rendered via an automated assistant).

In the above non-limiting working example, a frequency threshold can be set as “2”, meaning only tokens (or combination thereof) identified to have appeared more than or equal to twice in the log(s) 20 are considered frequent tokens (or token sets). As a result, frequent tokens (or frequent token sets) can be determined (with order of tokens not considered) to be:

| {a} | |
|---|---|
| {c} | |
| {d} | |
| {c, d} | |
| | (2) |

and frequent templates 21 can be determined (with order of tokens considered) to be:

| a | |
|---|---|
| c | |
| d | |
| | (3) |

It's noted that while {c, d} is determined as a frequent token set (based on tokens “c” and “d” appearing in the same query unit twice), “c d” (or “d c”) is not determined as a frequent template since “c” and “d” (while appearing twice, once in query unit “e d c” and once in query unit “c d”) do not appear more than once in the one or more log(s) 20 in the same order (e.g., c→d, or d→c). In various implementations, the frequent templates 21 ({a} {c}, and {d}) can be stored in a PII-free template database 23.

Continuing with the above non-limiting working example, each query unit in the three tokenized queries can be redacted to generate a corresponding redacted query unit, forming three redacted queries as shown below:

| a REDACTED | |
|---|---|
| c | |
| --- | |
| a | |
| REDACTED REDACTED c | |
| --- | |
| REDACTED d | |
| --- | (4) |

Continuing with the above non-limiting working example, the three redacted queries can be processed (e.g., by removing the word/token “REDACTED”) to generate three template units (e.g., a first template unit of “a c”, a second template unit of “a c”, and a third template unit of “d”) as shown below:

| --- | |
|---|---|
| a | |
| c | |
| --- | |
| a | |
| c | |
| --- | |
| d | |
| --- | (5) |

The three template units can be formatted into three template buckets (e.g., a first template bucket of {a, c}, a second template bucket of {a, c}, and a third template bucket of {d}, each corresponding to one tokenized query), which are shown as below:

| --- | |
|---|---|
| {a, c} | |
| --- | |
| {a, c} | |
| --- | |
| {d} | |
| --- | (6) |

From the template buckets, a plurality of frequent template sets can be determined and ranked from “1” to “N” in an order from a frequent template set having a lowest number of tokens (“lowest length”) to a frequent template set having a highest number of tokens (“highest length”), shown as below:

1. {a}
2. {c}
3. {a, c}
(7)

It should be noted that a frequent template set 21 can include permutations of one or more of the aforementioned frequent templates. As shown above, the frequent template sets can include a first frequent template set {a} corresponding to a key/ranking number “1” (which can also be used an ID for the first frequent template set), a second frequent template set {c} corresponding to a key number “2” (which can also be used an ID for the second frequent template set), and a third frequent template set {a, c} corresponding to a key number “3” (which can also be used an ID for the third frequent template set). It's noted that the template bucket {d} is not identified/determined as a frequent template set since the template bucket {d} does not appear more than once (when the frequency threshold is pre-configured to be, e.g., “2”) in the three template buckets. Additionally, a frequent template set {a, c} is determined by combining a frequent template set {a} and a frequent template set {c}. The frequent template set {a, c} is ranked below the frequent template set {a} and the frequent template set {c} by having a higher length.

In other words, the frequent template set {a, c} is a largest frequent template set, among all of the three frequent template sets derived from the logs (e.g., log(s) 20). In various implementations, during the index creation process, all frequent templates determined can be combined to generate a largest frequent template set.

In various implementations, the frequent template sets (including the first frequent template set {a}, the second frequent template set {c}, and the third frequent template set {a, c}) can also be stored in the PII-free template database 23, and can be stored in association with corresponding key numbers (“ranking numbers”, or “IDs”), i.e., “1”, “2”, and “3”.

Based on the ranked frequent template sets, a set-ID index can be generated as follows:

a: [1, 3]
c: [2, 3]
(8)

In the above set-ID index, {a} and {c} are frequent template sets, and for the frequent template set {a}, “1” and “3” are the IDs for the frequent template set(s) in (7) that contains the frequent template set {a}, i.e., {a} and {a, c}. Similarly, for the frequent template set {c}, “2” and “3” are the IDs for the frequent template set(s) in (7) that contains the frequent template set {c}, i.e., {c} and {a, c}.

In various implementations, the set-ID index can also be stored in the PII-free template database 23.

FIG. 3 schematically illustrates redaction of a user query using the set-ID index acquired in FIG. 2, in accordance with various implementations. As shown in FIG. 3, a query 32 (shown below) can be received from a human-to-computer dialog. The query 32 can include a first user utterance (e.g., tokenized) “a e”, a second user utterance “b”, a third system utterance “c”, and a fourth user utterance “d”, formatted as below:

| --- | |
|---|---|
| a e | |
| b | |
| c | |
| d | |
| --- | (9) |

Using the aforementioned frequent templates shown in (3), the query 32 can be redacted as follows, to keep only tokens that are determined as frequent templates (i.e., frequent templates “a”, “c”, “d”):

a REDACTED
REDACTED
c
d
(10)

By removing tokens representing “REDACTED” from the redacted query in (10), templates can be generated as follows:

a
c
d
(11)

Based on the set-ID index in (8), the template-set IDs can be determined as follows:

a: [1, 3]
c: [2, 3]
d: [ ]
(12)

Correspondingly, set-ID frequencies (frequency of each set in the set-ID index) can be determined as follows:

1: 1
2: 1
3: 2
(13)

Since the third frequent template set: {a, c} corresponds to a frequency of 2, which is greater than the frequency of the first frequent template set {a} (which is “1”) and is greater than the frequency of the second frequent template set {c} (which is “1”), the third frequent template set: {a, c} can be determined as the most frequent, it's verified that the third frequent template set contains the largest number of templates. The third frequent template set (i.e., {a, c}) can then be used to further redact the query 32 (i.e., keeping only tokens that are included in the third frequent template set and having all other tokens redacted), which results in a final redacted query shown as below:

| --- | |
|---|---|
| a REDACTED | |
| REDACTED | |
| c | |
| REDACTED | |
| --- | (14) |

In some implementations, (10) can be applied as the redacted query, for instance, to generate training data to train one or more machine learning models of an automated assistant. In some other implementations (e.g., when there are more strict privacy concerns), instead of (10), (14) can be applied as the redacted query, for instance, to generate training data to train one or more machine learning models of the automated assistant.

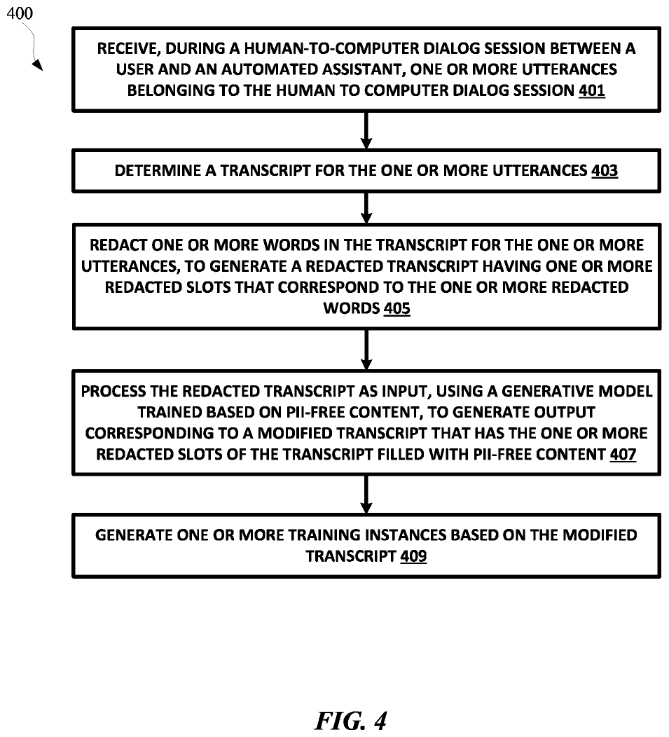

FIG. 4 depicts an example method of pseudonymization, in accordance with various implementations. For convenience, the operations of the method 400 are described with reference to a system that performs the operations. This system of the method 400 includes one or more processors and/or other component(s) of computing device(s) (e.g., client device 11 of FIG. 1, server device 12 of FIG. 1). Moreover, while operations of the method 400 are shown in a particular order, this is not meant to be limiting. One or more operations may be reordered, omitted, and/or added.

As shown in FIG. 4, at block 401, the system receives, during a human-to-computer dialog session between a user and an automated assistant, one or more utterances belonging to the human to computer dialog session. The one or more utterances can include, for instance, a first utterance from the user and a second utterance from the automated assistant. As a non-limiting example, the first utterance can be an utterance from the user, e.g., “what reminders do I have for Kira?”, and the second utterance can be a system utterance generated and rendered via the automated assistant, e.g., “You have a reminder to pick up Kira from the airport on May 3 at 5.”

Alternatively, the one or more utterances can include an utterance from the user and an additional utterance from the user. For example, the utterance from the user can be, e.g., “Turn on the light in Julie's room”, and the additional utterance from the user can be “also in Martha's room”. Alternatively, the one or more utterance can include and only include a single utterance from the user. For example, the single utterance from the user can be: “what reminders do I have for Kira?” The present disclosure is not intended to be limiting.

In various implementations, at block 403, the system determines a transcript for the one or more utterances. The system, for instance, can include a speech recognition engine to determine a transcript for utterance(s) received from the user. Continuing with the non-limiting example above, the speech recognition engine can process the utterance from the user (e.g., “what reminders do I have for Kira?) to generate a recognition/transcript for the utterance (e.g., “what reminders do I have for Kira?” in natural language). A transcript for the system utterance (e.g., “You have a reminder to pick up Kira from the airport on May 3 at 5”) can be determined by retrieving the transcript from one or more components from the automated assistant.

In various implementations, at block 405, the system redacts one or more words in the transcript for the one or more utterances, to generate a redacted transcript having one or more redacted slots that correspond to the one or more redacted words. In some implementations, the system can divide the transcript for the one or more utterances into one or more redacting units each corresponding to one of the one or more utterances. In other words, transcript for an individual utterance can be a redacting unit. Different redacting unit can be redacted individually.

In some implementations, prior to redacting the one or more words in the transcript for the one or more utterances, the system can tokenize the transcript for the one or more utterances, remove stopword(s) from the transcript for the one or more utterances (e.g., based on a stopword list that lists stopwords), change all uppercase letters in the transcript for the one or more utterances into lowercase, remove anything not belonging to letters and numbers from the transcript for the one or more utterances, and/or lemmatize the transcript for the one or more utterances. In case the stopword(s) are not removed, the system can be configured to ignore the stopword(s) when redacting the one or more words. In other words, the stopword(s) can be left or labeled as not to be redacted during the redacting of the one or more words.

In some implementations, at block 405, the system can redact the one or more words in the transcript for the one or more utterances by: accessing a PII-free template database for one or more template sets stored in the PII-free template database, and redacting the one or more words in the transcript for the one or more utterances based on the one or more template sets, where the one or more words are not included in any of the one or more template sets. As an example, the one or more template sets can include, for instance, a first template set corresponding to a first template (e.g., a single token appears more than a predefined threshold number of times in logs used to create the PII-free template database), a second template set corresponding to a second template (e.g., an additional single token appears more than the predefined threshold number of times in the logs used to create the PII-free template database), and a third template set corresponding the first template (e.g., the single token) and the second template (e.g., the additional single token). In this example, the one or more words in the transcript for the one or more utterances that do not belong to any of the first, second, or third template sets can be redacted, as the one or more words potentially reveal PII.

Continuing with the non-limiting example above where the transcript for the one or more utterance is “what reminders do I have for Kira? You have a reminder to pick up Kira from the airport on May 3 at 5.” in natural language, the one or more words “Kira”, “May 3”, and “5” can be redacted when such one or more words are not found in any of the template sets stored in the PII-free template database. This results in the redacted transcript, e.g., “what reminders do I have for REDACTED? You have a reminder to pick up REDACTED from the airport on REDACTED at REDACTED.”

In some implementations, additionally, the system can redact the one or more words in the transcript for the one or more utterances by: determining whether the transcription includes any entity name that has been referenced more than once in the transcript; and in response to determining that the transcription includes an entity name that has been referenced more than once in the transcript, replacing the entity name with a numbered reference slot. Continuing with the non-limiting example above where the transcript for the one or more utterance is “what reminders do I have for Kira? You have a reminder to pick up Kira from the airport on May 3 at 5”, the redacted transcript, e.g., “what reminders do I have for REFERENCE0? You have a reminder to pick up REFERENCE0 from the airport on REDACTED at REDACTED.”

In various implementations, at block 407, the system processes the redacted transcript as input, using a generative model trained based on PII-free content, to generate output corresponding to a modified transcript that has the one or more redacted slots of the transcript filled with PII-free content. The generative model can be, for instance, a multimodal model (e.g., transformer) trained in different languages and/or input modalities, which understands information across text and images. In some implementations, the generative model can be trained (e.g., using masking) to learn types of tokens that need to be filled in with PII-free content. For instance, the generative model can be trained to learn a first special token of “REDACTION” (or “REDACTED”) and one or more special tokens of “REFERENCE0”˜“REFERENCEn”, to replace the first and the one or more special tokens with PII-free content/token(s).

Continuing with the non-limiting example above where the transcript for the one or more utterance is “what reminders do I have for Kira? You have a reminder to pick up Kira from the airport on May 3 at 5”, the modified transcript that has the one or more redacted slots filled with PII-free content can be, for instance, “what reminders do I have for Tom? You have a reminder to pick up Tom from the airport on Monday at 1 pm”, where “Tom”, “Monday” and “1” are found in the template sets stored in the PII-free template database.

In various implementations, at block 409, the system generates one or more training instances based on the modified transcript. Continuing with the non-limiting example above where the modified transcript is “what reminders do I have for Tom? You have a reminder to pick up Tom from the airport on Monday at 1 pm”, the modified transcript is PII-free and can be applied as training data to further train a LLM that has been trained constantly on PII-free data.

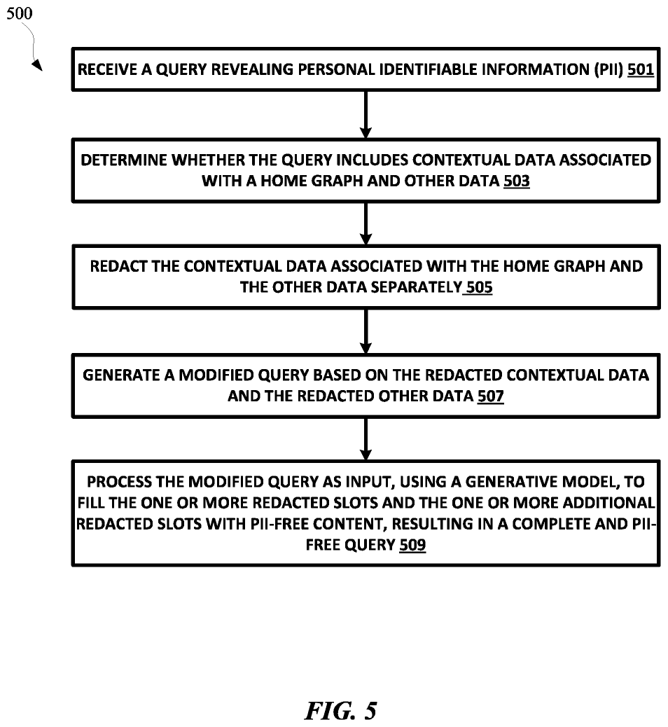

FIG. 5 depicts another example method of pseudonymization, in accordance with various implementations. For convenience, the operations of the method 500 are described with reference to a system that performs the operations. This system of the method 500 includes one or more processors and/or other component(s) of computing device(s) (e.g., client device 11 of FIG. 1, server device 12 of FIG. 1). Moreover, while operations of the method 500 are shown in a particular order, this is not meant to be limiting. One or more operations may be reordered, omitted, and/or added.

As shown in FIG. 5, at block 501, the system receives a query revealing personal identifiable information (PII). As a non-limiting example, the query, for instance, can be (noting that “Mike” and “TV” are PII):

Utterance: Turn off the TV in Mike's room
Home Graph: TV, ON, names: “Mike's living room”

In various implementations, at block 503, the system determines whether the query includes contextual data associated with a home graph and other data. Continuing with the example above, the query can be determined to include contextual data associated with a home graph (e.g., “Home Graph: TV, ON, names: “Mike's TV room”) and include the other data (e.g., Utterance: Turn off the TV in Mike's room). In this example, the utterance (“Turn off the TV in Mike's room”) and the contextual data associated with the home graph (e.g., “TV, ON, names: “Mike's TV room”) can be redacted separately. In other words, the utterance (“Turn off the TV in Mike's room”) can be redacted as whole, and the contextual data associated with the home graph (e.g., “TV, ON, names: “Mike's TV room””) can be separately redacted as whole.

In various implementations, at block 505, the system redacts the contextual data associated with the home graph and the other data separately. For instance, the system redacts the contextual data associated with the home graph, based on a first PII-free template database for home graphs, to generate redacted contextual data that includes one or more redacted slots. The system redacts the other data, based on a second PII-free template database that is separate from the first PII-free template database, to generate redacted other data that includes one or more additional redacted slots. The redacted query, for instance, can be as follows:

Utterance: Turn off the TV in REDACTED room
Home Graph: TV, ON, names: “REDACTD REDACTED room”

In some implementations, prior to redacting the contextual data associated with the home graph and the other data separately, a mixing approach is applied to the query to replace a device name (or room name, or structure name) in the query with other device name (or room name, or structure name) from a different structure. For instance, the query can become an altered query of:

Utterance: Turn off the TV in Mike's room
Home Graph: TV, ON, names: “TV” ″Mike's living room″

In some implementations, an entity (e.g., “Mike”) referenced more than once in the query but has not appeared enough times (or from enough different users) in logs used to create the first and/or second PII-free template databases can be determined. In these implementations, the entity (Mike or Mike's) can be replaced with a numbered reference slot (e.g., represented using the token “REFERENCE0”), so that the query becomes a modified query of:

Utterance: Turn off the TV in REFERENCE0 room
Home Graph: TV, ON, names: “TV” ″REFERENCE0 living room″

In various implementations, at block 507, the system generates a modified query based on the redacted contextual data and the redacted other data. Continuing with the example above, the modified query can be as follows:

Utterance: Turn off the TV in REFERENCE0 room
Home Graph: TV, ON, names: “TV” ″REFERENCE0 REDACTED
room″

In various implementations, at block 509, the system processes the modified query as input, using a generative model, to fill the one or more redacted slots and the one or more additional redacted slots with PII-free content, resulting in a complete and PII-free query. Continuing with the example above, the token “REFERENCE0” can be predicted as “Danas” (which according to the first PII-free template database, is PII-free), and the token “REDACTED” can be predicted as “study” (which according to the second PII-free template database, is PII-free). As a result, the redacted query filled with the PII-free content (i.e., the complete and PII-free query) predicted using the generative model can be as follows:

Utterance: Turn off the TV in Danas' room
Home Graph: TV, ON, names: “TV” ″Danas' study room″

In various implementations, the complete and PII-free query can be applied as training data to train the generative model (or other machine learning models).

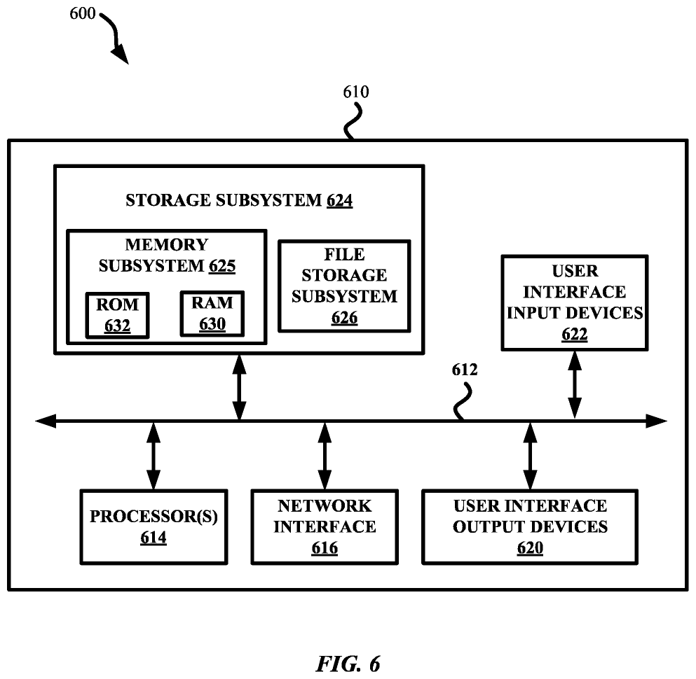

FIG. 6 is a block diagram of an example computing device 610 that may optionally be utilized to perform one or more aspects of techniques described herein. In some implementations, one or more of a client computing device, cloud-based automated assistant component(s), and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods disclosed herein, as well as to implement various components depicted in FIG. 1A.

These software modules are generally executed by processor 614 alone or in combination with other processors. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem may use multiple buses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

Different features of the examples can be combined or interchanged, unless they are not combinable nor interchangeable.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, and/or method described herein. In addition, any combination of two or more such features, systems, and/or methods, if such features, systems, and/or methods are not mutually inconsistent, is included within the scope of the present disclosure.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided, and includes: receiving, via a client device and during a human to computer dialog session between a user and an automated assistant, one or more utterances belonging to the human to computer dialog session; and processing the one or more utterances to generate a transcript for each utterance from the one or more utterances.

In some implementations, prior to identifying the one or more candidate words in the transcript that potentially convey PII, the method can include: removing stop words from the transcript.

Alternatively or additionally, in some implementations, the method can include: lemmatizing the transcript, prior to identifying the one or more candidate words in the transcript that potentially convey PII.

Alternatively or additionally, in some implementations, the method can include: converting all uppercase in the transcript to lowercase, prior to identifying the one or more candidate words in the transcript that potentially convey PII.

Alternatively or additionally, in some implementations, the method can include: removing non-alphanumeric tokens from the transcript, prior to identifying the one or more candidate words in the transcript that potentially convey PII.

In various implementations, the method further includes, for the transcript of each utterance from the one or more utterances: identifying one or more candidate words in the transcript that potentially convey personally identifiable information (PII); determining occurrences of the one or more candidate words in log of reference transcripts generated from historical human-to-computer dialogs; and based on the occurrences, flagging or labeling one or more of the candidate words as not conveying PII.

In various implementations, the method can further include: redacting one or more other words in the transcript based on one or more redacting rules, while preserving the one or more words flagged as not conveying PII, to generate a redacted transcript having one or more redacted slots that correspond to the one or more redacted words. Optionally, redacting the one or more other words can be realized, for instance, by replacing the one or more other words respectively with a word “REDACTED”. The one or more redacting rules, for instance, can include a modified Apriori algorithm as described above.

In various implementations, the method can further include: processing the redacted transcript as input, using a generative model trained based on redacted data, to generate output corresponding to a modified transcript that has the one or more redacted slots of the redacted transcript filled with PII-free content; and generating one or more training instances based on the modified transcript of each utterance from the one or more utterances. In some implementations, the method can further include: training a large language model based on the one or more generated training instances.

In some implementations, redacting the one or more other words in the transcript further includes: determining whether the transcript includes any entity name that has been referenced more than once throughout the one or more utterances; and in response to determining that the transcript includes an entity name that has been referenced more than once throughout the one or more utterances, replacing the entity name with a numbered reference slot.

In various implementations, another method implemented by one or more processors is provided, and includes: receiving a query; redacting, based on frequent templates stored in a PII-free template database, one or more words in the query not found in the frequent templates as potentially revealing personal identifiable information (PII); for each word in the query that is not redacted, determining frequent template sets in the PII-free template database that contain a respective word in the query that is not redacted; selecting a frequent template set from the determined frequent template sets that corresponds to a highest occurrence frequency; redacting, based on the selected frequent template set, one or more additional words in the query that is not found within the selected frequent template set as potentially revealing PII; and processing the query having the one or more redacted words and the one or more redacted additional words, using a generative model, to replace the one or more redacted words and the one or more redacted additional words with corresponding PII-free words, resulting in a PII-free query.

In some versions of the implementations above, the PII-free template database stores a plurality of frequent templates determined from query logs, and/or stores a plurality of frequent template sets derived from the plurality of frequent templates. The plurality of frequent template sets can also be indexed/listed with corresponding IDs, and the corresponding IDs can be stored in the PII-free template database in association with the frequent template sets.

In some implementations, each of the plurality of frequent templates corresponds to a PII-free word. In some implementations, each of the plurality of frequent template sets includes permutations of one or more of the frequent templates. In some implementations, the plurality of frequent template sets are ranked based on a length (or a total number) of words contained in each of the plurality of frequent template sets.

In some implementations, the method further includes: generating an instance of training data based on the PII-free query; and training the generative model or other machine learning model based on the instance of training data.

In some implementations, the query includes contextual data associated with a home graph. Alternatively or additionally, the query includes a user utterance received from a human user via an automated assistant. Alternatively or additionally, the query includes a system utterance generated and rendered via the automated assistant.

In some implementations, selecting the frequent template set from the determined frequent template sets that corresponds to the highest occurrence frequency includes: determining, based on listed IDs of the frequent template sets, a frequency of each frequent template set.

In various implementations, a system is provided and includes: one or more processors and memory storing instructions that, in response to execution by the one or more processors, cause the one or more processors to perform a method that includes: receive, via a client device and during a human to computer dialog session between a user and an automated assistant, one or more utterances belonging to the human to computer dialog session. The method can further include: process the one or more utterances to generate a transcript for each utterance from the one or more utterances.

In some implementations, the method further includes, for the transcript of each utterance from the one or more utterances: identify one or more candidate words in the transcript that potentially convey personally identifiable information (PII); determine occurrences of the one or more candidate words in log of reference transcripts generated from historical human-to-computer dialogs; and based on the occurrences, flag one or more of the candidate words as not conveying PII.

In some implementations, the method further includes: redact one or more other words in the transcript based on one or more redacting rules, while preserving the one or more words flagged as not conveying PII, to generate a redacted transcript having one or more redacted slots that correspond to the one or more redacted words; process the redacted transcript as input, using a generative model trained based on redacted data, to generate output corresponding to a modified transcript that has the one or more redacted slots of the redacted transcript filled with PII-free content; and generate one or more training instances based on the modified transcript of each utterance from the one or more utterances.

In some implementations of the system, the instructions to redact the one or more other words in the transcript further comprise instructions to: determine whether the transcript includes any entity name that has been referenced more than once throughout the one or more utterances; and in response to determining that the transcript includes an entity name that has been referenced more than once throughout the one or more utterances, replace the entity name with a numbered reference slot.

In some implementations of the system, the instructions to redact the one or more other words in the transcript further comprise instructions to: prior to identifying the one or more candidate words in the transcript that potentially convey PII, remove stop words from the transcript.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods. Some implementations also include a computer program product including instructions executable by one or more processors to perform any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

What is claimed is:

1. A method implemented by one or more processors, the method comprising:
receiving, via a client device and during a human to computer dialog session between a user and an automated assistant, one or more utterances belonging to the human to computer dialog session;
processing the one or more utterances to generate a transcript for each utterance from the one or more utterances;
for the transcript of each utterance from the one or more utterances:
identifying one or more candidate words in the transcript that potentially convey personally identifiable information (PII),
determining occurrences of the one or more candidate words in log of reference transcripts generated from historical human-to-computer dialogs, and
based on the occurrences, flagging one or more of the candidate words as not conveying PII;
redacting one or more other words in the transcript based on one or more redacting rules, while preserving the one or more words flagged as not conveying PII, to generate a redacted transcript having one or more redacted slots that correspond to the one or more redacted words;
processing the redacted transcript as input, using a generative model trained based on redacted data, to generate output corresponding to a modified transcript that has the one or more redacted slots of the redacted transcript filled with PII-free content; and
generating one or more training instances based on the modified transcript of each utterance from the one or more utterances.

2. The method of claim 1, wherein redacting the one or more other words in the transcript further comprises:
determining whether the transcript includes any entity name that has been referenced more than once throughout the one or more utterances, and
in response to determining that the transcript includes an entity name that has been referenced more than once throughout the one or more utterances, replacing the entity name with a numbered reference slot.

3. The method of claim 1, further comprising:
prior to identifying the one or more candidate words in the transcript that potentially convey PII, removing stop words from the transcript.

4. The method of claim 1, further comprising:
prior to identifying the one or more candidate words in the transcript that potentially convey PII, lemmatizing the transcript.

5. The method of claim 1, further comprising:
prior to identifying the one or more candidate words in the transcript that potentially convey PII, converting all uppercase in the transcript to lowercase.

6. The method of claim 1, further comprising:
prior to identifying the one or more candidate words in the transcript that potentially convey PII, removing non-alphanumeric tokens from the transcript.

7. The method of claim 1, wherein the one or more redacting rules include a modified Apriori algorithm.

8. The method of claim 1, further comprising:
training a large language model based on the one or more generated training instances.

9. A method implemented by one or more processors, the method comprising:
receiving a query;
redacting, based on frequent templates stored in a PII-free template database, one or more words in the query not found in the frequent templates as potentially revealing personal identifiable information (PII);
for each word in the query that is not redacted, determining frequent template sets in the PII-free template database that contain a respective word in the query that is not redacted;
selecting a frequent template set from the determined frequent template sets that corresponds to a highest occurrence frequency;
redacting, based on the selected frequent template set, one or more additional words in the query that is not found within the selected frequent template set as potentially revealing PII; and
processing the query having the one or more redacted words and the one or more redacted additional words, using a generative model, to replace the one or more redacted words and the one or more redacted additional words with corresponding PII-free words, resulting in a PII-free query.

10. The method of claim 9, wherein the PII-free template database stores a plurality of frequent templates determined from query logs, and a plurality of frequent template sets derived from the plurality of frequent templates.

11. The method of claim 10, wherein each of the plurality of frequent templates corresponds to a PII-free word.

12. The method of claim 10, wherein each of the plurality of frequent template sets includes permutations of one or more of the frequent templates.

13. The method of claim 10, wherein the plurality of frequent template sets are ranked based on a length of words contained in each of the plurality of frequent template sets.

14. The method of claim 9, further comprising:
generating an instance of training data based on the PII-free query; and
training the generative model or other machine learning model based on the instance of training data.

15. The method of claim 9, wherein the query includes contextual data associated with a home graph.

16. The method of claim 9, wherein the query includes a user utterance received via an automated assistant.

17. The method of claim 16, wherein the query includes a system utterance generated and rendered via the automated assistant.

18. The method of claim 9, wherein selecting the frequent template set from the determined frequent template sets that corresponds to the highest occurrence frequency comprises:
determining, based on listed IDs of the frequent template sets, a frequency of each frequent template set.

19. A system comprising one or more processors and memory storing instructions that, in response to execution by the one or more processors, cause the one or more processors to:
receive, via a client device and during a human to computer dialog session between a user and an automated assistant, one or more utterances belonging to the human to computer dialog session;
process the one or more utterances to generate a transcript for each utterance from the one or more utterances;
for the transcript of each utterance from the one or more utterances:
identify one or more candidate words in the transcript that potentially convey personally identifiable information (PII),
determine occurrences of the one or more candidate words in log of reference transcripts generated from historical human-to-computer dialogs, and
based on the occurrences, flag one or more of the candidate words as not conveying PII;
redact one or more other words in the transcript based on one or more redacting rules, while preserving the one or more words flagged as not conveying PII, to generate a redacted transcript having one or more redacted slots that correspond to the one or more redacted words;
process the redacted transcript as input, using a generative model trained based on redacted data, to generate output corresponding to a modified transcript that has the one or more redacted slots of the redacted transcript filled with PII-free content; and
generate one or more training instances based on the modified transcript of each utterance from the one or more utterances.

20. The system of claim 19, wherein the instructions to redact the one or more other words in the transcript further comprise instructions to:
determine whether the transcript includes any entity name that has been referenced more than once throughout the one or more utterances, and
in response to determining that the transcript includes an entity name that has been referenced more than once throughout the one or more utterances, replace the entity name with a numbered reference slot.

21. The system of claim 19, wherein the instructions to redact the one or more other words in the transcript further comprise instructions to:
prior to identifying the one or more candidate words in the transcript that potentially convey PII, remove stop words from the transcript.
